(19) United States
(12) Patent Application Publication
(10) Pub. No.: US 2024/0376313 A1
(43) Pub. Date: Nov. 14, 2024

(54) POLYAMIDE RESIN COMPOSITION AND MOLDED ARTICLE FORMED FROM SAME

(71) Applicant: KOLON PLASTICS, INC., Gimcheon (KR)

(72) Inventors: Jae Min KIM, Gimcheon (KR); Heon Kyu JEONG, Gimcheon (KR); Gi Bong CHUNG, Gimcheon (KR)

(21) Appl. No.: 18/689,988

(22) PCT Filed: Sep. 27, 2022
(86) PCT No.: PCT/KR2022/014495

§ 371 Date: Mar. 7, 2024

(30) Foreign Application Priority Data
Oct. 6, 2021 (KR) 10-2021-0132507

(51) Int. Cl. C08L 77/10; F17C 1/16

(52) U.S. Cl. CPC C08L 77/10; F17C 1/16; C08L 2201/14; C08L 2205/025; C08L 2205/035; F17C 2203/0604; F17C 2203/066; F17C 2221/012

(57) ABSTRACT

The present invention relates to a polyamide resin composition and a molded article formed from same, the polyamide resin composition comprising: polyamide 6; long-chain polyamide; an impact modifier; and polyamide 66, aromatic polyamide, and a combination thereof.

### TECHNICAL FIELD

A polyamide resin composition and a molded article formed from same are disclosed.

### BACKGROUND ART

Recently, hydrogen cars using hydrogen as an energy source have been drawing attention as environmentally-friendly transportation vehicles. As the hydrogen has a risk of explosion, various parts for storing and transporting the hydrogen should have safety at a high level and functionality.

A hydrogen tank storing the hydrogen may internally have a plastic liner, wherein such a hydrogen tank liner requires high rigidity to withstand high-pressure hydrogen and durability to maintain performance during repeatedly charging the hydrogen. Specifically, the hydrogen tank liner should have excellent tensile elongation to withstand the high-pressure hydrogen and high gas barrier properties to prevent transmission of the hydrogen and in addition, because the hydrogen is charged by creating a low-temperature environment, realize excellent tensile elongation and durability even at the low temperature. There is a need to develop plastic materials simultaneously satisfying these properties.

### DISCLOSURE

### Description of the Drawings

### Technical Problem

Provided is a polyamide resin composition having excellent mechanical properties, high gas barrier properties, and excellent durability at room temperature and a low temperature and a molded article formed from the same.

### Technical Solution

An embodiment provides a polyamide resin composition including polyamide 6; long-chain polyamide; impact modifier; and polyamide 66, aromatic polyamide, or a combination thereof and a molded article formed from same.

### Advantageous Effects

The polyamide resin composition according to an embodiment and the molded article formed from the same realize excellent mechanical properties such as tensile elongation and the like and also, excellent gas barrier properties, chemical resistance, and durability at a low temperature of −40° C. as well as room temperature.

### MODE FOR INVENTION

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

Herein “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, the particle size or average particle diameter may be measured by a method well known to those skilled in the art, and may be, for example, measured by a particle size analyzer, or may be measured by a transmission electron microscopic image or a scanning electron microscopic image. Alternatively, it is possible to obtain an average particle diameter value by measuring using a dynamic light scattering method (DLS), performing data analysis, counting the number of particles for each particle size range, and calculating from this. Unless otherwise defined, the average particle diameter may mean the diameter (D50) of particles having a cumulative volume of 50 volume % in the particle size distribution.

In an embodiment, a polyamide resin composition includes polyamide 6; long-chain polyamide; an impact modifier; and polyamide 66, aromatic polyamide, and a combination thereof. Such a polyamide resin composition exhibits excellent mechanical properties such as tensile elongation and the like at room temperature and a low temperature of −40° C., high gas barrier properties, and excellent durability.

### Polyamide 6

Polyamide 6 (PA 6) refers to polyamide made from ε-caprolactam or 6-aminocaproic acid and in some cases, made by copolymerization of different monomers. The polyamide 6 has excellent mechanical strength such as tensile elongation and the like and also, excellent chemical resistance and formability.

The polyamide 6 may have relative viscosity of 1.8 to 3.4, for example 2.0 to 3.0, or 2.3 to 2.8. Herein, the relative viscosity may be measured with a viscometer by adding 1 g of the polyamide 6 to 100 ml of 96% sulfuric acid at 20° C. The relative viscosity of the polyamide 6, which satisfies the ranges, may exhibit excellent mechanical strength and maintain appropriate fluidity during the injection.

The polyamide 6 may include an amino terminal group in an amount of 1.0×10⁻⁵ to 10.0×10⁻⁵ mol/g without a particular limit, which may sufficiently secure a polymerization degree and thereby, improve mechanical strength and the like.

The polyamide 6 may be manufactured in a well-known method or selected from commercially available products.

The polyamide 6 may be included in an amount of 10 wt % to 80 wt %, for example, 20 wt % to 80 wt %, 30 wt % to 80 wt %, 40 wt % to 80 wt %, 45 wt % to 75 wt %, or 50 wt % to 70 wt % based on 100 wt % of the polyamide resin composition. When the polyamide 6 is included within the ranges, the polyamide resin composition may realize excellent mechanical characteristics, durability, and formability.

### Long-Chain Polyamide

The long-chain polyamide is polyamide having a long carbon chain at a repeating unit and specifically, polyamide having 8 to 20 carbon atoms per 1
nitrogen atom in one repeating unit. Herein, the number of carbon atoms per 1 nitrogen atom may be, for example, 8 to 18, 8 to 16, 8 to 14, or 8 to 12. A polyamide resin composition according to an embodiment includes the
long-chain polyamide and thus may improve mechanical properties such as tensile elongation and the like at a low temperature.

The long-chain polyamide may include, for example PA8, PA9, PA10, PA11, PA12, PA13, PA48, PA410, PA412, PA414, PA418, PA58, PA510, PA512, PA514, PA518, PA68, PA610, PA612, PA614, PA618, PA88, PA810, PA812, PA1010, PA1012, PA1014, PA1018, PA1210, PA1212, PA1214, PA1218, PA1410, PA1412, PA1414, PA1418, PAST, PA9T, PA10T, PA12T, PA8I, PA9I, PA10I, PA12I, a copolymer thereof, or a combination thereof. The long-chain polyamide may be a homopolymer or a copolymer.

As an example, the long-chain polyamide may include PA11, PA12, PA610, PA612, PA618, PA1010, PA1012, PA1212, a copolymer thereof, or a combination thereof. In this case, the tensile elongation of the polyamide resin composition at low temperatures can be significantly improved.

The long-chain polyamide may have a conventional molecular weight and relative viscosity of 1.8 to 4.0 when measured in 98 wt % of a sulfuric acid solution at 25° C.

A content of the long-chain polyamide may be 1 wt % to 25 wt %, for example, 1 wt % to 20 wt %, 1 wt % to 15 wt %, 1 wt % to 10 wt %, 2 wt % to 8 wt %, or 3 wt % to 7 wt % based on 100 wt % of the polyamide resin composition. When the content ranges are satisfied, the polyamide resin composition may realize excellent mechanical strength and durability at a low temperature.

### Impact Modifier

The polyamide resin composition according to an embodiment includes an impact modifier and thereby, may realize a resin with high strength. The impact modifier may be, for example, a polyolefin-based rubber, and may include, for example an ethylene-propylene rubber, an ethylene-propylene-diene rubber, an ethylene-octene rubber, an ethylene-vinyl acetate rubber, or a combination thereof. They can significantly improve the impact strength of the polyamide resin composition without deteriorating other physical properties.

The impact modifier may be one modified with maleic anhydride, and may be, for example, a polyolefin-based rubber grafted with maleic anhydride, specifically, an ethylene-octene rubber grafted with maleic anhydride. These materials may improve miscibility of resin components such as the polyamide 6 and the like with the impact modifier.

A content of the impact modifier may be 10 wt % to 50 wt %, for example, 10 wt % to 45 wt %, 10 wt % to 40 wt %, 15 wt % to 35 wt %, or 20 wt % to 30 wt % based on 100 wt % of the polyamide resin composition. When the content of the impact modifier satisfies the ranges, the polyamide resin composition may improve tensile elongation, durability, and chemical resistance at a low temperature as well as exhibit excellent impact strength.

### Polyamide 66, Aromatic Polyamide, or Combination Thereof

The polyamide resin composition according to an embodiment may further include at least one of polyamide 66 and aromatic polyamide in addition to the above components and thus significantly improve tensile elongation at a low temperature of −40° C. Such a polyamide resin composition may be suitably used as a material for a high-performance hydrogen tank liner.

### Polyamide 66

The polyamide 66 (PA 66) refers to polyamide made from hexamethylenediamine and adipic acid and in some cases, a copolymer of other monomers. The polyamide 66 exhibits excellent mechanical strength, chemical resistance, and formability.

The polyamide 66 has relative viscosity of 1.7 to 3.1. Herein, the polyamide 66 may be continuously produced due to appropriate melt tension and have excellent miscibility with other components such as glass fiber and the like. Herein, the relative viscosity may be measured by adding 1 g of the polyamide 66 to 100 ml of 96% sulfuric acid at 20° C. with a viscometer.

The polyamide 66 may have, for example, a weight average molecular weight of 11,000 g/mol to 21,000 g/mol. When the weight average molecular weight is less than the range, thermal stability of the polyamide 66 may be deteriorated, but when out of the range, because a screw torque of an extruder may increase, productivity may be deteriorated.

The polyamide 66 may be manufactured by a well-known method or selected from commercially available products.

The polyamide 66 in a predetermined amount is added to the polyamide resin composition to improve tensile elongation at a low temperature.

### Aromatic Polyamide

The aromatic polyamide is a semi-aromatic polyamide having amide groups structure and partially, aromatic groups and a polyamide including an aromatic structure with 6 carbons among the amide groups and a benzene bond structure.

Specific examples of the aromatic polyamide may include polyamide 6I, polyamide 6I/66, polyamide 6T/6I/66, polyamide 6T, polyamide 6T/66, polyamide 6T/DT, and polyamide 9T. For example, the aromatic polyamide may be polyamide 6I. The polyamide 6I in a predetermined amount is added to the polyamide resin composition to improve tensile elongation at a low temperature without deteriorating other properties.

The aromatic polyamide may have a melting point of about 280° C. to 330° C. and a glass transition temperature of about 80° C. to 180° C. The aromatic polyamide may have a conventional molecular weight.

A content of the polyamide 66, the aromatic polyamide, or a combination thereof may be 5 wt % to 20 wt %, for example, 5 wt % to 15 wt %, or 7 wt % to 13 wt % based on 100 wt % of the polyamide resin composition. When the ranges are satisfied, the polyamide resin composition may realize excellent chemical resistance, durability, and the like as well as excellent mechanical strength at a low temperature.

On the other hand, in the polyamide resin composition, (the long-chain polyamide):(the polyamide 66, the aromatic polyamide, or a combination thereof) may have a weight ratio of 10:90 to 50:50, for example, 20:80 to 40:60, etc. When the weight ratios are satisfied, the tensile elongation at a low temperature may be maximized, and in addition, price competitiveness may be achieved.

### Other Additives

The polyamide resin composition may further include other additives as needed. The other additives may include, for example, a plasticizer, a flame retardant, a heat resistant agent, an antioxidant, a reinforcing agent, a release agent, a dye, a pigment, an ultraviolet ray absorber, a nucleating agent, a lubricant, or a combination thereof.

The other additives may be included in an amount of 0 wt % to 10 wt %, for example, 0.1 wt % to 9 wt %, 0.1 wt % to 6 wt %, 0.1 wt % to 5 wt %, 0.1 wt % to 4 wt %, 0.1 wt % to 3 wt %, 0.1 wt % to 2 wt %, or 0.2 wt % to 1 wt % based on a total weight of the polyamide resin composition. Herein, a purpose of a corresponding additive may be achieved without affecting other physical properties.

The polyamide resin composition may include 10 wt % to 80 wt % of polyamide 6; 1 wt % to 20 wt % of long-chain polyamide; 10 wt % to 50 wt % of an impact modifier; 5 wt % to 20 wt % of polyamide 66, aromatic polyamide, or a combination thereof; and 0 wt % to 10 wt % of other additives.

Specific examples of the polyamide resin composition may include 45 wt % to 75 wt % of polyamide 6; 1 wt % to 10 wt % of long-chain polyamide; 15 wt % to 35 wt % of an impact modifier; 5 wt % to 15 wt % of polyamide 66, aromatic polyamide, or a combination thereof; and 0 wt % to 5 wt % of other additives.

Such a polyamide resin composition exhibits excellent mechanical characteristics and excellent chemical resistance and durability and particularly, excellent mechanical characteristics such as tensile elongation at a low temperature and the like and thus may be suitable as a material for a hydrogen storage part in a device using hydrogen as an energy source, for example, a polyamide resin composition for a hydrogen tank liner.

An embodiment provides a molded article comprising the aforementioned polyamide resin composition. The molded article may be, for example, a hydrogen storage device in a transportation system using hydrogen as energy, for example, a hydrogen tank liner for a hydrogen vehicle.

The molded article according to an embodiment may have tensile elongation of 70% or more at a low temperature of −40° C.

### DETAILED DESCRIPTION OF THE EMBODIMENTS

Hereinafter, examples and comparative examples of the present invention are described. The following examples are only examples of the present invention, but the present invention is not limited thereto.

### Example 1

60 wt % of polyamide 6 (PA6), 5 wt % of PA1012 as long-chain polyamide, 25 wt % of ethylene-octene rubber (EOR) as an impact modifier, and 10 wt % of polyamide 66 (PA66) are mixed and extruded with an extruder to prepare a polyamide resin composition.

The polyamide resin composition is extruded by changing an extrusion temperature from 250° C. to 280° C. and a screw speed from 250 rpm to 450 rpm and then, cooled to manufacture a pellet. The obtained pellet is injected into an injection molding machine to manufacture a molded article as a multi-purpose test specimen.

### Example 2

A composition and a molded article are manufactured in the same manner as in Example 1 except that PA6I is used instead of PA66.

### Example 3

A composition and a molded article are manufactured in the same manner as in Example 1 except that a combination of PA66 and PA6I is used instead of PA66.

### Example 4

A composition and a molded article are manufactured in the same manner as in Example 2 except that 25% of the long-chain polyamide is used.

### Comparative Examples 1 and 2

A composition and a molded article are manufactured in the same manner as in Example 1 except that each component is used in an amount shown in Table 1 without using PA66.

### Comparative Example 3

A composition and a molded article are manufactured in the same manner as in Example 1 except that each component is used in an amount shown in Table 1 without using the long-chain polyamide.

### Comparative Example 4

A composition and a molded article are manufactured in the same manner as in Example 1 except that each component is used in an amount shown in Table 1 without using the impact modifier.

TABLE 1

| | PA6 | PA1012 | EOR | PA66 | PA6I |
|---|---|---|---|---|---|
| Example 1 | 60 | 5 | 25 | 10 | 0 |
| Example 2 | 60 | 5 | 25 | 0 | 10 |
| Example 3 | 60 | 5 | 25 | 5 | 5 |
| Example 4 | 40 | 25 | 25 | 0 | 10 |
| Comparative Example 1 | 70 | 5 | 25 | 0 | 0 |
| Comparative Example 2 | 50 | 25 | 25 | 0 | 0 |
| Comparative Example 3 | 65 | 0 | 25 | 10 | 0 |
| Comparative Example 4 | 85 | 5 | 0 | 10 | 0 |

### Evaluation Examples

The molded articles according to the examples and the comparative examples are evaluated with respect to tensile strength, tensile elongation, and impact strength at room temperature (23° C.) and a low temperature (−40° C.) in the following method, and the results are shown in Table 2.

The tensile strength and the tensile elongation are evaluated according to ISO 527 under a condition of 50 mm/min.

The Izod impact strength is evaluated by using a 3.2 mm-thick specimen with a notch in the center and a 5.5 J impact hammer at 23° C. according to ISO 180.

In addition, after aging a specimen at −40° C. for 4 hours in a chamber maintaining an atmosphere of −40° C. with liquid nitrogen, the specimen is evaluated with respect to properties at a low temperature such as tensile strength, tensile elongation, and Izod impact strength.

TABLE 2

| | Room temperature (23° C.) | | | Low temperature (−40° C.) | | |
|---|---|---|---|---|---|---|
| | Tensile | Tensile | Impact | Tensile | Tensile | Impact |
| | strength | elonga- | strength | strength | elonga- | strength |
| | MPa | tion % | kJ/m² | MPa | tion % | kJ/m² |
| Example 1 | 56 | 262 | 110 | 63 | 105 | 76 |
| Example 2 | 55 | 275 | 105 | 67 | 71 | 73 |
| Example 3 | 56 | 269 | 105 | 64 | 75 | 73 |
| Example 4 | 55 | 270 | 103 | 58 | 51 | 56 |
| Comparative | 52 | 229 | 110 | 67 | 21 | 70 |
| Example 1 | | | | | | |
| Comparative | 52 | 270 | 106 | 59 | 45 | 67 |
| Example 2 | | | | | | |
| Comparative | 55 | 275 | 105 | 67 | 33 | 56 |
| Example 3 | | | | | | |
| Comparative | 74 | 97 | 6 | 111 | 10 | 3 |
| Example 4 | | | | | | |

Referring to Table 2, Examples 1 to 4 exhibit excellent properties such as tensile strength, tensile elongation, impact strength, and the like at both room temperature and low temperature. On the contrary, Comparative Example 1 using neither PA 66 nor PA 6I exhibits significantly low tensile elongation at the low temperature, and Comparative Example 2, in which a content of the long-chain polyamide is increased, exhibits increased tensile elongation, compared with Comparative Example 1, but does not reach those of the examples. Comparative Example 3 using no long-chain polyamide has a problem of significantly low tensile elongation at the low temperature, and Comparative Example 4 using no impact modifier also has problems of significantly low impact strength at the room temperature and the low temperature and low tensile elongation at the low temperature due to processing problems.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A polyamide resin composition, comprising
polyamide 6;
long-chain polyamide;
an impact modifier; and
polyamide 66, aromatic polyamide, or a combination thereof.

2. The polyamide resin composition of claim 1, wherein
a relative viscosity of the polyamide 6 is 1.8 to 3.4.

3. The polyamide resin composition of claim 1, wherein
the long-chain polyamide is a polyamide with 8 to 20 carbon atoms per nitrogen atom in one repeating unit, and
the long-chain polyamide includes PA8, PA9, PA10, PA11, PA12, PA13, PA48, PA410, PA412, PA414, PA418, PA58, PA510, PA512, PA514, PA518, PA68, PA610, PA612, PA614, PA618, PA88, PA810, PA812, PA1010, PA1012, PA1014, PA1018, PA1210, PA1212, PA1214, PA1218, PA1410, PA1412, PA1414, PA1418, PAST, PA9T, PA10T, PA12T, PA8I, PA9I, PA10I, PA12I, a copolymer thereof, or a combination thereof.

4. The polyamide resin composition of claim 1, wherein
the long-chain polyamide includes PA11, PA12, PA610, PA612, PA618, PA1010, PA1012, PA1212, a copolymer thereof, or a combination thereof.

5. The polyamide resin composition of claim 1, wherein
the long-chain polyamide is included in an amount of 1 wt % to 25 wt % based on 100 wt % of the polyamide resin composition.

6. The polyamide resin composition of claim 1, wherein
the impact modifier includes an ethylene-propylene rubber, an ethylene-propylene-diene rubber, an ethylene-octene rubber, an ethylene-vinyl acetate rubber, or a combination thereof.

7. The polyamide resin composition of claim 1, wherein
a relative viscosity of polyamide 66 is 1.7 to 3.1.

8. The polyamide resin composition of claim 1, wherein
the aromatic polyamide has a melting point of 280° C. to 330° C. and a glass transition temperature of 80° C. to 180° C.

9. The polyamide resin composition of claim 1, wherein
the polyamide 66, aromatic polyamide, or combination thereof is included in an amount of 5 wt % to 20 wt % based on 100 wt % of the polyamide resin composition.

10. The polyamide resin composition of claim 1, wherein
a weight ratio of the (long-chain polyamide):(polyamide 66, aromatic polyamide, or a combination thereof) is 10:90 to 50:50.

11. The polyamide resin composition of claim 1, wherein
based on 100 wt % of the polyamide resin composition,
10 wt % to 80 wt % of the polyamide 6;
1 wt % to 25 wt % of the long-chain polyamide;
10 wt % to 50 wt % of the impact modifier;
5 wt % to 20 wt % of the polyamide 66, aromatic polyamide, or a combination thereof; and
0 wt % to 10 wt % of other additives.

12. The polyamide resin composition of claim 11, wherein
based on 100 wt % of the polyamide resin composition,
45 wt % to 75 wt % of the polyamide 6;
1 wt % to 10 wt % of the long-chain polyamide;
15 wt % to 35 wt % of the impact modifier;
5 wt % to 15 wt % of the polyamide 66, aromatic polyamide, or combination thereof; and
0 wt % to 5 wt % of other additives.

13. The polyamide resin composition of claim 11, wherein
the other additives include a plasticizer, a flame retardant, a heat resistant agent, an antioxidant, a reinforcing agent, a release agent, a dye, a pigment, an ultraviolet ray absorber, a nucleating agent, a lubricant, or a combination thereof.

14. A molded article formed from the polyamide resin composition of claim 1.

15. The molded article of claim 14, wherein
the molded article is a hydrogen tank liner.
